(19) United States
(12) Patent Application Publication
(10) Pub. No.: US 2024/0065489 A1
(43) Pub. Date: Feb. 29, 2024

(54) WASHABLE MAT MATERIAL AND SYSTEM

(71) Applicant: Ruggable LLC, Gardena, CA (US)

(72) Inventors: Lydia Wei-Ju Chen, Lakewood, CA (US); Leonard John Duran, Torrance, CA (US); William Stanhope St. Amant, Los Angeles, CA (US); Robert Westphal Vera, New York, NY (US); Therese Mona-Lisa Germain, Los Angeles, CA (US); Max Flanders Sieck, Los Angeles, CA (US)

(73) Assignee: Ruggable LLC, Gardena, CA (US)

(21) Appl. No.: 17/823,081

(22) Filed: Aug. 30, 2022

(51) Int. Cl. A47K 3/00; B32B 5/02; B32B 5/06; B32B 5/18; B32B 5/24; B32B 5/26; B32B 7/12; B32B 27/12; B32B 27/40

(52) U.S. Cl. CPC A47K 3/002; B32B 5/022; B32B 5/024; B32B 5/026; B32B 5/06; B32B 5/18; B32B 5/245; B32B 5/266; B32B 7/12; B32B 27/12; B32B 27/40; B32B 2262/0276; B32B 2266/0207; B32B 2266/12; B32B 2274/00; B32B 2307/56; B32B 2307/72; B32B 2307/7265; B32B 2307/744; B32B 2471/04

(57) ABSTRACT

In various embodiments, a washable mat system comprises a top cover removably attached to a bottom pad. The top cover comprises layers of material, including a top layer with a tufted loop pile, a water-resistant internal layer, and a bottom knit surface. The top cover is sufficiently malleable to be folded, rolled, compressed, and withstand multiple wash and dry cycles while maintaining material stability. The bottom pad also comprises layers of material, including a top layer to removably attach to the bottom knit surface of the top cover, an internal cushioning layer, and a non-slip bottom surface.

### BACKGROUND

### Technical Field

This disclosure relates to a washable mat material and system that may be used for various applications, including particularly for use in bath mats, but also in kitchen mats, rugs, and other floor coverings.

### Background Art

Bath mats are some of the most commonly used items in households and other places with baths and showers. There are a few characteristics commonly thought of as being desirable for bath mats. For one, it is desirable for bath mats to be absorbent and quick drying as they are typically used in high moisture environments and often have water spill on them. It is also desirable for bath mats to be easy to clean, or even washable in a washing machine. Many bathrooms present a warm and damp environment that tends to facilitate the growth of bacteria, making the washability of bath mats all the more important, as washing helps rid the bath mats of bacterial growth. Another desirable characteristic for bath mats is for them to resist slipping, which is a particular concern in wet environments.

### SUMMARY

Some bath mats currently available today may exhibit a number of downsides. Some bath mats are not resistant to the growth of bacteria, which can be undesirable because high moisture environments can be conducive to bacterial growth. Material used to make bath mats can be lent a degree of antibacterial properties by infusing them with copper, silver, charcoal, hemp, or similar ingredients.

As already noted, it is desirable for bath mats to be absorbent. Absorbency in a bath mat is helpful insofar as it eliminates or reduces the collection or pooling of water on the surface of the mat. However, some bath mats are water absorbent without being particularly water resistant, such that, for instance, water can soak all the way through the mat and collect on the floor. The collection of water on the floor can damage or reduce the life of the floor surface. It can also reduce the slip resistance of a bath mat, making the bath mat less safe to use.

Typically, slip resistance for a bath mat is achieved by applying a layer of PVC, latex, silicone, or similar material to the bottom surface of the mat. The anti-slip layer may be applied as a coating, e.g., to a floor-facing fabric surface, or it may be manufactured as a discrete layer of material that is then attached to fabric material to make a bath mat. The anti-slip layer may further feature textures, such as dimples, treads, and protrusions, to increase the slip resistance of the bath mat. However, the anti-slip layer of many bath mats tends to deteriorate over time, which causes it to lose some of its effectiveness. The deterioration of the anti-slip material may be accelerated by washing a bath mat in a washing machine, where the mat may endure prolonged exposure to water and heat. Once the anti-slip material has deteriorated to a sufficient degree, the mat would shift and move around on the floor, causing a safety hazard.

Moreover, the anti-slip layer used in some existing bath mats products are relatively thin and lightweight so that the mat would be sufficiently malleable to be folded or rolled up and washed in a washing machine. The downside of this approach is that the anti-slip layer would be quicker to deteriorate compared to a thicker anti-slip layer. However, the use of a thicker anti-slip layer may cause the bath mat to be too stiff to easily wash in a washing machine.

FIG. 1 shows an example of a prior art bath mat 100 that is characteristic of some but not all existing bath mat products. This bath mat 100 exhibits poor material stability, which is manifested as wrinkles 101 on its top surface. The wrinkles 101 may catch a person's foot as she walks across the bath mat 100, and thus presents a safety hazard. The wrinkles 101 may also be considered by some to be aesthetically undesirable.

FIGS. 2 and 3 show examples of prior art bath mats 200 and 300 that are characteristic of some but not all existing bath mat products. Bath mat 200 exhibits curling 201 at its corners, while bath mat 300 exhibits curling 301 at its corners. The curling on these bath mats may present tripping hazards and may also be considered aesthetically unappealing.

The problems shown in the examples depicted in FIGS. 1-3 may be exacerbated by washing and drying of the bath mats. Many existing bath mat products look good and function well at the start but start to exhibit shrinkage, dimensional instability, and/or the curling of corners or edges over time, particularly as they go through multiple wash/dry cycles.

Accordingly, there is a need for a bath mat product that provides some of the benefits of existing products while improving on downsides exhibited by some existing products.

Disclosed is a washable mat material and system that may be used for various applications, particularly for use in bath mats, but also in kitchen mats, rugs, and other floor coverings. Some embodiments provide a two-piece system. Other embodiments provide a one-piece system.

### BRIEF DESCRIPTION OF THE DRAWINGS

FIG. 1 shows an example of a prior art bath mat that exhibits wrinkles.

FIG. 2 shows an example of a prior art bath mat that exhibits curling at its corners.

FIG. 3 shows an example of a prior art bath mat that exhibits curling at its edges.

FIG. 4 is a perspective view of an exemplary two-piece bath mat system with a top cover and a bottom pad according to an embodiment of the disclosure.

FIG. 5A is a perspective view of an exemplary top cover comprising a stack of layers according to an embodiment of the disclosure.

FIG. 5B is a side view of the top cover of FIG. 5A.

FIG. 6A is a perspective view of an exemplary bottom pad comprising a stack of layers according to an embodiment of the disclosure.

FIG. 6B is a side view of the bottom pad of FIG. 6A.

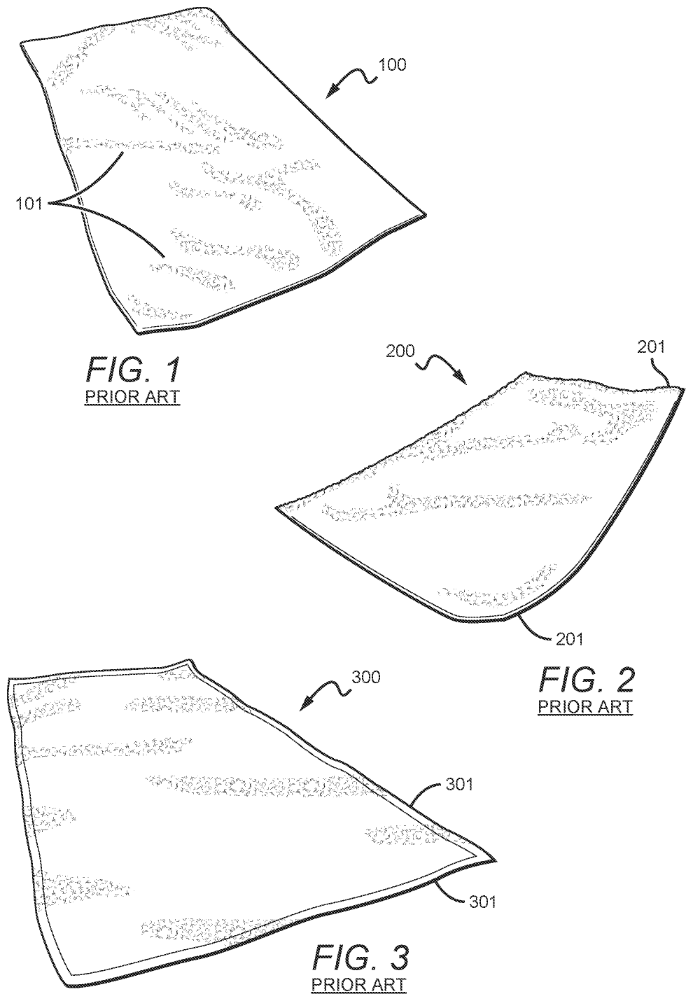

### DETAILED DESCRIPTION

This disclosure relates to a washable mat material and system that may be used for various applications, including particularly for use in bath mats, but also in kitchen mats, rugs, and other floor coverings.

### Terms

The terms listed below each include their plain and ordinary meaning known to a person of skill in the art, which includes at least the provided information.

“Denier” is a unit of measurement of the thickness/weight of yarn. One denier is equal to the mass in grams per 9,000 meters of thread.

“GSM” means grams per square meter (g/m 2).

“Pile” means the raised surface of a fabric, usually including upright loops or strands of yarn.

Two-Piece Bath Mat System

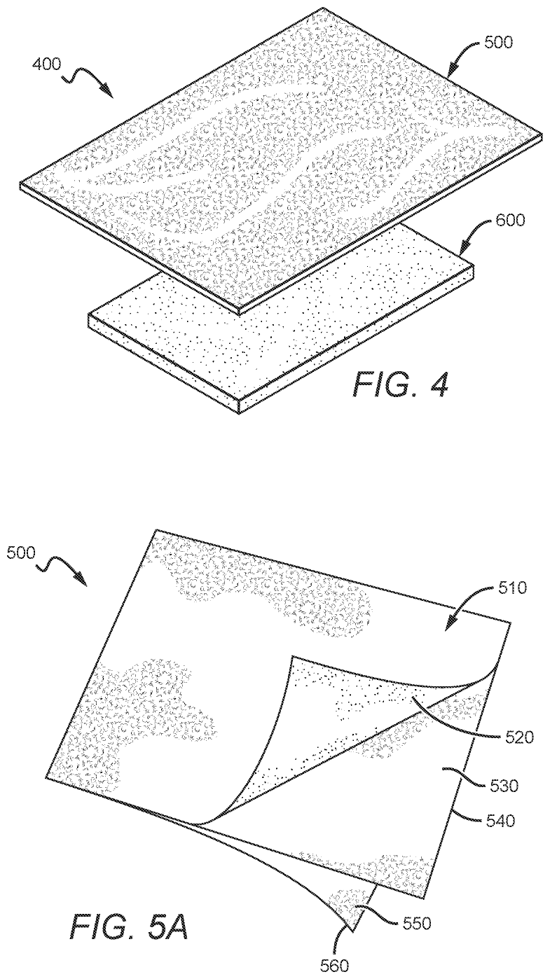

With reference to FIG. 4, a two-piece mat system 400 according to an embodiment of the disclosure includes a top cover 500 and a bottom pad 600. The top cover 500 is designed to removably attach to the bottom pad 600, such as by use of the mechanisms described in U.S. Pat. No. 8,309,198, incorporated in its entirety by reference. The top cover 500 may be removed from the bottom pad 600 for washing, and may be designed to be sufficiently malleable so that it can be folded or rolled up to fit in a washing machine and dryer. The top cover 500 is both absorbent and water resistant so that water does not soak through the mat system 400 and collect on the floor. Because the top cover 500 is water resistant, the bottom pad 600 would tend to get less soiled and would require fewer washings than the top cover 500. Thus, the bottom pad 600 may be designed to be less frequently washed and/or be designed to be washed by hand rather than by machine, which would better preserve its anti-slip properties. The lack of need to have the bottom pad 600 be machine-washable allows it to be made to be relatively thick and/or less malleable, so that it could be disposed with thicker and/or higher quality anti-slip materials. In some embodiments, the bottom pad 600 may be omitted and a layer of anti-slip material may instead be disposed on the bottom surface of the top cover 500. In other embodiments, the top cover 500 and bottom pad 600 may be fashioned as an integrated whole rather than a separable two-piece system.

Stack Layers of the Top Cover

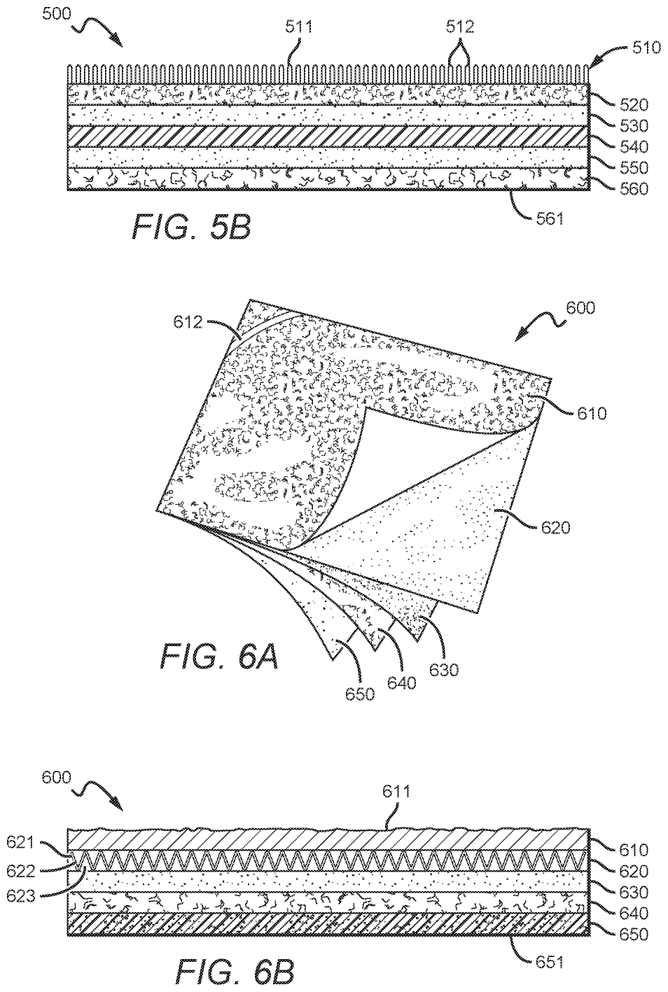

FIGS. 5A and 5B show the top cover 500 as a stack of layered materials. In various embodiments, the layered materials comprise four layers interspersed by adhesives as follows.
A first material layer 510 comprises a tufted loop pile face.
A second material layer 520 comprises a woven base into which yarns are tufted to form the tufted loop pile face of the first material layer 510.
A third material layer 540 comprises a thermoplastic polyurethane. The polyurethane provides a liquid barrier that prevents, for example, spills or stains from penetrating deep into the stack.
A hot melt adhesive 530 bonds the second material layer 520 to the third material layer 540.
A fourth material layer 560 comprises a knit backing.
A hot melt adhesive 550 bonds the third material layer 540 to the fourth material layer 560.

In an embodiment, the top cover 500 comprising the layers above has a thickness in the range of about 4 mm to about 8 mm, such as about 6 mm, which renders the top cover 500 amenable to various production processes, such as the application of heat and pressure to bond the layers. Available machinery and techniques for applying heat and/or pressure may be limited in the thickness of input materials. The same may be true for available machinery and techniques for applying surface treatment to the top cover 500, such as color application processes.

The layers of the top cover 500 are described in more detail below. It would be appreciated by a skilled artisan from the disclosure herein that embodiments or implementations may arrange the layers in a different order, use a different material for a particular layer, use additional or fewer layers, have liquid resistant layers that reduce rather than eliminate liquid passthrough, or make other changes, all without departing from the spirit or scope of this disclosure.

Layer 1: Tufted Loop Pile Surface

As shown in FIGS. 5A and 5B, the first material layer 510 of the top cover 500 comprises a tufted loop pile surface 511. This first layer 510 contributes significantly to the look and feel of the top cover 500 as it is the outer facing portion of the top cover 500 and thus would be most often touched by a person. For instance, if a bath mat or rug were made of the top cover 500, then this first layer would provide the top surface that would be stepped on by a person.

The first layer 510 comprises yarns 512 that are tufted through the second layer 520 to create a tufted loop pile face 511. The yarns 512 are preferably selected to provide a satisfying foot feel, exhibit relatively little pilling, and be water absorbent while also being quick to dry. In a preferred embodiment, the weight of the yarns 512 may be in the range of about 4050 denier to about 4950 denier. More preferably, the weight of the yarns 512 may be in the range of about 4275 denier to about 4725 denier, such as about 4500 denier. The yarns 512 may have a density in the range of about 484.5 GSM to about 655.5 GSM. More preferably, the density of the yarns 512 may be in the range of about 513 GSM to about 627 GSM, such as about 570 GSM. The pile height of the tufted loop pile surface 511 may be in the range of about 2 mm to about 8 mm. More preferably, the pile height of the tufted loop pile surface 511 may be in the range of about 3 mm to about 6 mm, such as about 4 mm.

In preferred embodiments, the tufted loop pile face 511 may be made at least in part of polyester or other like material. The yarns may be dyed into a desired color before they are affixed to the second layer 520, such as a white or other light color that is amenable to subsequent treatment using industrial dyeing or other color application processes. The top-facing loop surface of the pile also further optimizes the efficacy of color application because the loops provide more surface area for receiving surface treatment as compared to yarns sticking straight up. Preferably, the tufted loop pile face 511 is engineered to be of relatively uniform pile height to further enhance its ability to receive surface treatments—the uniformity of the pile height helps ensure that any surface application would be taken in a uniform fashion. The ability of the surface layer 510 to accept surface treatments allows for the creation of a limitless range of designs and aesthetics for the bath mat.

Although disclosed with specific reference to materials and manufacturing processes, an artisan will recognize from the disclosure herein different embodiments with different or alternative materials and/or manufacturing processes that accomplish the look and feel of a comfortable top surface that is absorbent yet quick drying. For example, materials such as acrylic, modacrylic, polypropylene, rayon, and nylon may be used instead of or in junction with the above.

Layer 2: Woven Base

As shown in FIGS. 5A and 5B, the second material layer 520 of the top cover 500 comprises a woven base through which the yarns 512 of the first material layer are tufted. Preferably, the second material layer 520 provides a stabilizing base for the yarns 512 and also the overall structure of the top cover 500. The second material layer 520 contributes to the dimensional stability of the top cover 500, and helps reduce the incidence of issues such as wrinkling of the top surface and/or curling of the corners or edges. This layer also provides some protection against liquid penetration.

In an embodiment, the second material layer 520 is woven using polyester yarns having a density in the range of about 157.5 GSM to about 192.5 GSM. More preferably, the density of the yarns may be in the range of about 166.25 GSM to about 183.75 GSM, such as about 175 GSM.

Although disclosed with specific reference to materials and manufacturing processes, an artisan will recognize from the disclosure herein different embodiments with different or alternative materials and/or manufacturing processes that accomplish the aim of a stabilizing base for the yarns of the tufted loop pile face. For example, materials such as acrylic, modacrylic, polypropylene, rayon, and nylon may be used instead of or in junction with the above.

Adhesive

The adhesive 530 comprises an adhesive optimized for bonding synthetic fabric materials. It operates to adhere the second material layer 520 (the woven base) of the top cover 500 to the lower layers, and most directly the third layer 540. The selected adhesive material should be flexible and should retain its adhesive properties to keep the material layers together through rolling and folding and multiple wash and dry cycles. The adhesive 530 may be a 60 GSM polyurethane (PUR) hot melt adhesive comprised of NEL-1016 material. This adhesive has been found to withstand heat exposure during the production process of the top cover 500 as well as through multiple wash and dry cycles.

Although disclosed with specific reference to polyurethane, an artisan will recognize from the disclosure herein different or alternative bonding materials and/or manufacturing processes that adhere the material layers. For example, materials such as thermoplastic polyurethane adhesive may be used instead of or in junction with the above.

Layer 3: Thermoplastic Polyurethane—Liquid Barrier

The third layer 540 shown in FIGS. 5A and 5B comprises a sheet of material that prevents liquids, including water from seeping through the stack. This layer may be omitted in some embodiments, particularly if liquid resistance is not needed for a particular use case. The layer should be thick enough to prevent seepage but thin enough to allow the overall top cover 500 to maintain flexibility. It has been found that 15 GSM thermoplastic polyurethane (TPU) works well for this purpose, though it is possible to use TPU of other weights, or a different material altogether.

Although disclosed with specific reference to polyurethane, an artisan will recognize from the disclosure herein different or alternative liquid resistant or liquid barrier layers. For example, it is possible to lend a degree of liquid resistance to fabric by the application of spill-resistant coatings, but this may be less preferable as a number of the coatings available on the market contain PFAS chemicals, some of which are deemed to be dangerous and are currently banned or may become banned in some countries and U.S. states.

Adhesive

With continued reference to FIGS. 5A and 5B, an adhesive 550 bonds the third layer 540 (liquid barrier) to the fourth layer 560 (knit base). In some embodiments, the adhesive 550 is similar or the same as adhesive 530 disclosed above. Although disclosed as using adhesives between each material layer, an artisan will recognize from the disclosure herein that adhesives may absorb through one or more particular material layers to adhere or bond more than two material layers together in the stack. Moreover, pressure rolling and/or heat treating may additionally allow for the use of fewer adhesives between each material layer than as depicted in FIGS. 5A and 5B.

Layer 4: Knit Backing—Base

The fourth layer 560 may be the bottom layer of the stack of materials comprising the top cover 500. It may comprise a knit loop material of polyester yarn (e.g., of 50 denier and 120 GSM) such that its bottom surface 561 may removably attach to hook material disposed on the top surface of the bottom mat 600. Alternatively, the fourth layer 560 may comprise hook material while loop material is disposed on the bottom pad 600.

Alternatively, the fourth layer may itself comprise a bottom pad, or one or more additional layers may be placed or adhered below the fourth layer to provide a pad for the top cover 500, allowing it to be used as a bath mat without a separate bottom pad. In still other embodiments, the base layer is configured to contact the floor or ground.

Although disclosed with specific reference to materials and manufacturing processes, an artisan will recognize from the disclosure herein different embodiments with different or alternative materials and/or manufacturing processes for the base layer. For example, materials such as velvet, fleece, felt, and thermoplastic elastomer (TPE) may be used instead of or in junction with the above.

Stack Layers of the Bottom Pad

FIGS. 6A and 6B show the bottom pad 600 as a stack of layered materials. In various embodiments, the layered materials comprise four layers interspersed by adhesives as follows.
A first material layer 610 comprises a cling surface.
A second material layer 620 comprises a cushioning layer with comfortable foot feel and compression and recovery.
A third material layer 640 comprises a polyester felt layer to prevent creasing and to provide more surface area for application of anti-slip material.
An adhesive 630 bonds the second material layer 620 to the third material layer 640.
A fourth material layer 650 provides a non-slip base.

The layers of the bottom pad 600 are described in more detail below. It would be appreciated by a skilled artisan from the disclosure herein that embodiments or implementations may arrange the layers in a different order, use a different material for a particular layer, use additional or fewer layers, or make other changes, all without departing from the spirit or scope of this disclosure.

Layer 1: Needle-Punched Cling Surface

As shown in FIGS. 6A and 6B, the first material layer 610 of the bottom pad 600 comprises a needed-punched top surface 611. The primary function of this first layer 610 is to provide a surface to attach to the knit material of bottom surface 561 of the fourth layer 560 of the top cover 500. Effectively, the bottom surface 561 functions as loop material and the needle-punched surface 611 functions as hook material to allow the top cover 500 and bottom pad 600 to removably attach to each other. In an embodiment, the first material layer may have a thickness of about 3.5 mm and a fabric weight of about 500 GSM.

As shown in FIG. 6A, the top surface 611 of the first material layer 610 may be disposed with a strap 612. The strap 612 may be made of various materials, including polypropylene and/or polyester, and can be sewn to the bottom pad 600 or attached to it in other ways. The strap 612 is preferably sized to fit standard household hangers and hooks so as to allow the bottom pad 600 to be air dried.

Although disclosed with specific reference to materials and manufacturing processes, an artisan will recognize from the disclosure herein different embodiments with different or alternative materials and/or manufacturing processes for the cling surface layer. For example, materials such as thin polyester hooks may be used instead of or in junction with the above.

Layer 2: Cushioning

With continued reference to FIGS. 6A and 6B, the second layer 620 comprises a cushioning layer. In a preferred embodiment, the second layer 620 comprises non-woven polyester fibers 621 arranged into a repeating “V” or zig-zag pattern 622 that is then heat set to form a series of open-cell structures 623. As shown in FIG. 6B, the “V” pattern 622 is shown as arranged vertically in the stack of materials, but it can also be arranged horizontally or in some other orientation. In some embodiments, the open-cell structures 623 provide stack breathability, and resist high pressure and crushing. For example, the open-cell structures 623 compress from the pressure of someone stepping on the bottom pad 600 (or the mat system 400 of which the bottom pad 600 is a part) and decompress when the pressure is removed.

The polyester fibers 621 preferably have a thickness in the range of about 7 mm to about 15 mm. More preferably, the polyester fibers 621 have a thickness in the range of about 10 mm to about 12 mm, such as about 11 mm.

Although disclosed with specific reference to materials and manufacturing processes, an artisan will recognize from the disclosure herein different embodiments with different or alternative materials and/or manufacturing processes that accomplish the cushioning for the stack. For example, different cushioning structures, or materials such as 3D spacer fabric, V-Lap, or memory foam may be used instead of or in junction with the above.

Adhesive

The adhesive 630 comprises an adhesive optimized for bonding synthetic fabric materials. It operates to adhere the second material layer 620 (the cushioning layer) of the bottom pad 600 to the lower layers, and most directly the third layer 640.

The adhesive 630 may be the same adhesive used for the top cover. Alternatively, particularly where it is not necessarily needed for the bottom pad 600 to be machine-washable, a different adhesive may be used. For example, the adhesive may be approximately a 50 GSM (give or take 5 GSM) blend of prepolymer of MDI and polyol and diphenylmethane-diisocyanate, which allows the multi-layer bonding to withstand hand washing and air drying.

An artisan will recognize from the disclosure herein different or alternative bonding materials and/or manufacturing processes that adhere the material layers. For example, materials such as thermoplastic polyurethane adhesive may be used instead of or in junction with the above.

Layer 3: Base/Bonding Layer

With continued reference to FIGS. 6A and 6B, the third layer 640 may function as a base layer for bonding the other layers of the bottom pad 600, particularly material layer 4 (non-slip base). It also helps prevent the bottom pad 600 from creasing. In an embodiment, the third layer 640 comprises a non-woven polyester felt that provides a large surface area for the application of the latex material of material layer 4. Preferably, the polyester felt has a fabric weight in the range of about 135 GSM to about 165 GSM, such as about 150 GSM.

Although disclosed with specific reference to materials and manufacturing processes, an artisan will recognize from the disclosure herein different embodiments with different or alternative materials and/or manufacturing processes that accomplish providing a base for bonding non-slip material and other layers. For example, different materials such as knitted or woven fabrics may be used instead of or in junction with the above.

Layer 4: Non-Slip Base

With continued reference to FIGS. 6A and 6B, the fourth layer 650 provides a bottom surface (floor facing surface) 651 for the bottom pad 600. In a preferred embodiment, the fourth layer 650 comprises a gel foam latex composition that is applied to the third layer 640. Preferably, as applied, the latex material has a thickness in the range of about 0.5 mm to about 3.5 mm. More preferably, the latex material has a thickness in the range of about 1.0 mm to about 2.0 mm, such as about 1.5 mm. Further, the latex material preferably has a weight of about 455 GSM to about 845 GSM. More preferably, the latex material has a weight of about 552.5 GSM to about 747.5 GSM, such as about 650 GSM. This material has been found to exhibit high slip resistance on various types of floor surfaces, including vinyl, ceramic tile, hardwood, and more. It satisfies ASTM F609 Slip indexes and the National Floor and Safety Institute index, and has been proven by Bureau Veritas to be considered a high-traction product for both wet and dry conditions.

Although disclosed with specific reference to materials and manufacturing processes, an artisan will recognize from the disclosure herein different embodiments with different or alternative materials and/or manufacturing processes that accomplish a non-slip surface. For example, different materials such as thermoplastic elastomers (TPE), thermoplastic rubber (TPR), modified hot melt polymer, neoprene, styrene-butadiene rubber (SBR), polyvinyl chloride (PVC), or silicone may be used instead of or in junction with the above.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including, “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

As used herein, a phrase referring to “at least one of” a list of items refers to any combination of those items, including single members. As an example, “at least one of A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure and the principles and the novel features disclosed herein.

1. A two-piece mat system comprising a top cover and a bottom pad, wherein:
the top cover comprises:
a first top-facing layer comprising a tufted loop pile surface;
a first stability layer providing a base for the tufted loop pile surface;
a liquid barrier layer; and
a bottom-facing layer comprising a knit surface; and
the bottom pad comprises:
a second top-facing layer configured to removably attach to the bottom-facing layer of the top cover;
a cushioning layer providing a predefined cushioning for the bottom pad;
a non-slip layer comprising a latex composition; and
a second stability layer interposed above the non-slip layer and which provides a surface area for application of the latex composition.

2. The two-piece mat system of claim 1, further comprising adhesive.

3. The two-piece mat system of claim 1, wherein the liquid barrier layer comprises polyurethane.

4. The two-piece mat system of claim 1, wherein the first stability layer comprises woven polyester.

5. The two-piece mat system of claim 1, wherein the second top-facing layer comprises a needle-punched polyester material.

6. The two-piece mat system of claim 1, wherein the cushioning layer comprises a plurality of open-cell structures of polyester material.

7. The two-piece mat system of claim 1, wherein the bottom pad further comprises a hanging strap.

8. The two-piece mat system of claim 1, wherein the tufted loop pile surface has a pile height within a range of about 2 mm to about 8 mm.

9. The two-piece mat system of claim 1, wherein the tufted loop pile surface has a pile height within a range of about 3 mm to about 6 mm.

10. The two-piece mat system of claim 1, wherein the tufted loop pile surface has a pile height of about 4 mm.

11. The two-piece mat system of claim 1, wherein the tufted loop pile comprises a plurality of polyester yarns having a density within a range of about 484.5 GSM to 655.5 GSM.

12. The two-piece mat system of claim 1, wherein the tufted loop pile comprises a plurality of polyester yarns having a density within a range of about 513 GSM to 627 GSM.

13. The two-piece mat system of claim 1, wherein the tufted loop pile comprises a plurality of polyester yarns having a density of about 570 GSM.

14. The two-piece mat system of claim 1, wherein the second top-facing layer comprises a needle-punched polyester material.

15. The two-piece mat system of claim 1, wherein the second top-facing layer comprises a needle-punched polyester material having a thickness of about 3.5 mm and a density of about 500 GSM.

16. A material comprising:
a top-facing layer comprising a tufted loop pile surface;
a stability layer providing a base for the tufted loop pile surface;
a liquid barrier layer; and
a cushioning layer providing a predefined cushioning for the material; and
a bottom-facing layer.

17. The material of claim 16, wherein the bottom-facing comprises a knit surface configured to be removably attached to a separate pad.

18. The material of claim 16, wherein the bottom-facing comprises a non-slip surface.

19. The material of claim 16, wherein the tufted loop pile surface has a pile height within a range of about 3 mm to about 6 mm.

20. The material of claim 16, wherein the tufted loop pile comprises a plurality of polyester yarns having a density within a range of about 513 GSM to 627 GSM.
